(19) United States
(12) Patent Application Publication
(10) Pub. No.: US 2025/0385328 A1
(43) Pub. Date: Dec. 18, 2025

(54) WIPING SYSTEM FOR ELECTRODE IN ELECTROCHEMICAL CELL

(71) Applicant: e-Zinc Inc., Mississauga (CA)

(72) Inventors: Petrus Theodorus DE KONING, Toronto (CA); Andrew Michael MEDEIROS, Oakville (CA); Izaz ULLAH, Parsippany, NJ (US)

(73) Assignee: e-Zinc Inc., Mississauga, ON (CA)

(21) Appl. No.: 18/867,512

(22) PCT Filed: Jun. 7, 2023
(86) PCT No.: PCT/CA2023/050773

§ 371 Date: Nov. 20, 2024

Related U.S. Application Data
(60) Provisional application No. 63/350,051, filed on Jun. 8, 2022.

(51) Int. Cl. H01M 10/44; H01M 4/02

(52) U.S. Cl. CPC H01M 10/44; H01M 4/02; H01M 2004/028

(57) ABSTRACT

A wiper system for an electrode in an electrochemical cell utilizes a wiper blade in contact with a surface of the electrode, a blade support having a blade mount on which the wiper blade is mounted, the blade support biasing the wiper blade toward the surface of the electrode to provide a uniformly distributed contact force between a surface of the wiper blade and the surface of the electrode, a translatable carriage on which the blade support is mounted, a carriage drive on which the carriage is mounted to translate the carriage through space, and a chassis on which the carriage drive is mounted, the chassis permitting the wiper blade to contact the electrode during operation of the wiper system.

### CROSS-REFERENCE TO RELATED APPLICATIONS

This application claims the benefit of United States Provisional patent application U.S. Ser. No. 63/350,051 filed Jun. 8, 2022, the entire contents of which is herein incorporated by reference.

### FIELD

This application relates to electrochemical cells, in particular to devices and methods for keeping an electrode free of materials deposited on the electrode during operation of the electrochemical cell.

### BACKGROUND

Typical charge/discharge type electrochemical cells comprise a tank containing a reservoir of electrolyte in which electrodes (cathodes and anodes) are situated, the tank housing a discharging section generally located at or near a bottom of the tank and a charging section generally located at or near a top of the tank, with a storage section located in between the charging and discharging sections. The charging section operates to store electrical energy in the electrochemical cell and the discharging section operates to deliver the stored electrical energy to operate an electrical device. The charging and discharging sections are generally not operated at the same time.

Charge/discharge type electrochemical cells typically utilize Zn/Zn²⁺ half reactions in a basic aqueous electrolyte. The charging section comprises charge anodes and charge cathodes at which the following chemical reactions occur during a charging operation:

### Charge Anode:

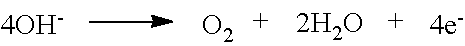

### Charge Cathode:

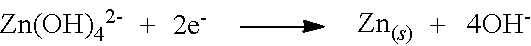

Elemental zinc solid formed at the charge cathode can be removed from the charge cathode by a means of wiping or scraping. The elemental zinc then theoretically falls to the bottom of the electrochemical cell under the influence of gravity to collect on metal current collectors, which carry current to operate electrical devices when the solid zinc is converted back to Zn(OH)₄²⁻ during a discharge operation of the electrochemical cell. However, known zinc removal systems have one or more disadvantages including uneven distribution of force across the charge plate causing zinc to smear across the charge cathode and compact in subsequent wipe cycles producing a hard, crusty zinc deposit eventually causing wiper/scraper breakage; too low of normal force with respect to the charge cathode which eventually results in wiper/scraper breakage; too high of normal force with respect to the charge cathode leading to binding on the charge cathode; and, high power requirements to drive the wiper mechanism decreasing the overall efficiency of the system, and high part costs.

Therefore, there is a need in some types of electrochemical cells for a mechanism to efficiently remove deposits of material (e.g., elemental zinc) from an electrode during operation of the electrode without stopping the operation, with low cost and without being unduly energy parasitic, especially operation of a charging cathode during a charging operation.

### SUMMARY

A wiper system for an electrode in an electrochemical cell comprises: a wiper blade configured to contact a surface of the electrode; a blade support having a blade mount on which the wiper blade is mounted, the blade support configured to bias the wiper blade toward the surface of the electrode to provide a contact force between a surface of the wiper blade and the surface of the electrode; a translatable carriage on which the blade support is mounted; a carriage drive on which the carriage is mounted, the carriage drive configured to translate the carriage through space; and, a chassis on which the carriage drive is mounted, the chassis permitting the wiper blade to contact the electrode during operation of the wiper system.

An electrochemical cell comprises: a tank for holding an electrolyte; at least one electrode disposed in the electrolyte, the at least one electrode having a surface on which metal deposits during operation of the cell; and, a wiper system described above mounted on the tank so that the wiper blade is in contact with the surface on which metal deposits and the carriage translates along the electrode.

The wiping system is suitable for wiping metal deposits of material from an electrode in an electrochemical cell. The material is preferably an electrodeposited metal, for example zinc, copper, lead and the like. The cell is preferably a charge-discharge electrochemical cell. The electrode is typically a cathode. The wiper system is particularly useful for wiping deposits on charging cathodes. The electrochemical cell comprises a tank for holding an electrolyte. At least one electrode, preferably a plurality of electrodes, is disposed in the electrolyte. The at least one electrode has a surface on which material, e.g., a metal, deposits during operation of the cell. The wiper system is mounted to the tank so that the wiper blade is in contact with the surface on which material deposits and the carriage translates along the electrode.

In contrast to many other electrochemical cells that store their energy products on the electrode, the wiping mechanism allows “mechanically dressing or reconditioning” of the electrode surface with each wipe and prevents long term surface change effects that other cells experience such as swelling, expansion, deformation and un-controlled dendrites that result in degradation/early cycle life failure.

The wiping system comprises a chassis. The chassis is configured to be mountable on the electrochemical cell, preferably at a top of the cell on the tank. The chassis provides a mount on which other parts of the wiper system can be configured and acts as the interface between the wiper system and the tank. The chassis permits the wiper system to register to the tank, which in turn registers the electrodes and thus enables the wiper blade to contact the electrode during operation of the wiper system. The chassis can be made of any suitable non-electrically conducting material, for example polymeric material such as engineering plastics (e.g., polyoxymethylene (POM)). The chassis may be a single monolithic piece or constructed in separate parts. The chassis may be a part of the tank.

A carriage drive is mounted on the chassis. A translatable carriage is mounted on the carriage drive. The carriage may comprise a block of material connectable to the carriage drive so that the carriage drive can translate the carriage longitudinally in the chassis. The carriage drive may comprise, for example, any combination of drive rods, motors, gears, pulleys, timing belts or chains, and the like. In some embodiments, the carriage drive may be a threaded drive rod (i.e., a lead screw) rotationally coupled to a motor whereby the threaded drive rod is matingly meshed with a complementary internally threaded aperture in the carriage so that rotation of the drive rod causes the carriage to translate through space along the threaded drive rod. The internally threaded aperture may be machined directly into a custom component of the carriage drive or may be the threads of a captured nut captured within the carriage. The threaded drive rod may be rotatable in both rotational directions to be able to translate the carriage toward a front or a rear of the chassis. The drive rod may be mounted on one or more bearings mounted in the chassis. The threaded drive rod preferably does not translate with respect to the chassis. In other embodiments, a rack and pinion mechanism may be used with appropriate gears connecting the rack or pinion mechanism to a motor. In other embodiments, timing belts/chains and pulleys may operatively connect the carriage to a motor to drive the carriage on a track. In other embodiments, the carriage drive could be an electric actuator or a hydraulic actuator such as a hydraulic cylinder. The carriage comprises a suitable connection to permit operably mounting of the carriage to the carriage drive.

The wiper system may further comprise at least one guide rod, preferably at least two guide rods, mounted on the chassis parallel to the drive rod. The translatable carriage may be mounted on the at least one guide rod to reduce rotational motion of the carriage as the carriage translates on the drive rod. The guide rods react to moments in Mx (racking moments), My (fore/aft cantilever moments) and Mz (rotation around the axis of the lead screw). Preferably, the wiper system comprises a plurality of guide rods, for example two guide rods. In some embodiments, the drive rod is centrally located along a longitudinal axis of the chassis. Preferably, there are guide rods situated laterally from the drive rod toward sides of the chassis. The guide rods are preferably spaced apart from the drive rod by a distance that prevents twisting of the carriage during translation of the carriage without causing binding of the carriage on the guide rods. The carriage may be mounted in the guide rods by virtue of through-apertures in the carriage through which the guide rods are inserted. To provide smooth sliding, the through-apertures have linear bearing quality mechanical fits or bushing inserts.

At least one blade support is mounted on the carriage, preferably rigidly in the direction of motion of the wiper blade stroke, but free to pivot and slide transverse to the direction of motion of the wiper blade stroke. Preferably, a plurality of blade supports, for example 1, 2, 3, 4, 5 or 6 blade supports, are mounted on the carriage. Where a plurality of blade supports is used, the blade supports are preferably spaced apart laterally from each other with respect to a direction of translation of the translatable carriage. The at least one blade support preferably extends downwardly from the carriage into the electrolyte in the tank of the cell. The blade support may be mounted on the carriage by any suitable method, for example, with a pin (e.g., a bolt, screw, rivet or the like), welding, gluing, stapling, clamping and the like. The blade support may comprise a mounting point at which the blade support is mounted to the carriage. In some embodiments, the mounting point comprises an aperture through which a pin may be inserted. Preferably, the blade support is mounted on the carriage in a manner that enables some transverse and rotational mechanical degrees of freedom for to accommodate manufacturing misalignments to the electrodes that would otherwise result in high motor loads (parasitic losses), binding and/or breakage. A pin-in-slot arrangement is particularly preferred for this reason.

The blade support may comprise one or more arms. Preferably, the blade support is forked comprising a plurality of arms. More preferably, the blade support comprises two spaced-apart arms. Preferably, the arms meet at the mounting point for the blade support. The blade support comprises at least one blade mount to which a wiper blade may be mounted. The wiper blade is a separate part from the at least one blade mount to provide the wiper blade with rotational degree of freedom and a spring preload. Preferably, each arm comprises a blade mount. In some embodiments, the blade mount comprises a through-aperture.

The wiper blade comprises a contact surface that contacts the electrode when the wiper blade is wiping the electrode. The wiper blade may be cambered to generate a uniformly distributed normal force profile to the electrode over the length of the wiper blade when wiping the electrode. The wiper blade also comprises a mounting portion to permit mounting the wiper blade on the blade support on the blade support. The wiper blade may be mounted to the blade mount of the blade support by any suitable method, for example, with a pin (e.g., a bolt, screw, rivet or the like), welding, gluing, stapling, clamping and the like. Preferably, the wiper blade is mounted to the blade mount in a manner that enables some transverse and rotational mechanical degrees of freedom for the wiper blade. In some embodiments, the wiper blade comprises an apertured clevis that brackets an arm of the blade support such that the through-aperture of the blade mount aligns with the apertures in the clevis so that a pin can be inserted through the three apertures to secure the wiper blade to the blade support. In a preferred embodiment, the blade support comprises two arms and one wiper blade is mounted on each arm such that the contact surfaces of the two wiper blades are opposed and facing each other. In such an arrangement, an electrode can be disposed between the two wiper blades on the same blade support so that during the wiping operation, opposed faces of the electrode can be wiped simultaneously by one blade support.

The blade support is configured to bias the wiper blade toward the surface of the electrode to provide a contact force between the wiper blade and the surface of the electrode. The biasing may be accomplished by actuators, springs and the like, but making the blade support, including the arms, of a resilient polymer material is simpler and more robust. When the blade support comprises a resilient polymer material, the resiliency of the polymer material biases the wiper blade toward the surface of the electrode. The blade support preferably applies a biasing force to a middle portion of the wiper blade to balance load along the wiper blade when the wiper blade is in contact with the surface of the electrode. When two wiper blades are on the same blade support, the two wiper blades are opposed to each other and are biased toward each other by two arms of the blade support.

The blade support, the wiper blade or both may be made of any suitable non-electrically conducting material that can withstand the forces of the wiping operation. Preferably, the material is a polymeric material, more preferably an engineering plastic, for example an acrylic, which is resilient and can provide the biasing force needed to bias the wiper blade toward the surface of the electrode.

The wiper system is cost effective, simple and efficiently removes deposits of material (e.g., elemental zinc) from an electrode during operation of the electrode without stopping the operation and without being unduly energy parasitic. The wiper system is especially useful for wiping a charging cathode during a charging operation.

There is a relationship between charging efficiency and wiping frequency. Lower wiping frequency leads to higher charging efficiencies, therefore it is desirable to keep wiping frequency as low as possible, which also reduces parasitic energy loss from operating the wiping system and reduces wear and tear. The best cell efficiency arises from a balance of concentration of the electrolyte, contact force of the wiper blade on the surface of the electrode, wiping frequency and size of conduction growth sites on the electrode. The wiping system described herein permits an excellent balance of these factors to keep charging rate high while eliminating uncontrolled dendrite formation with a low wiping frequency to reduce parasitic energy loss.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 is a perspective view of a first embodiment of a wiper system for wiping an electrode in an electrochemical cell.

FIG. 2 is a perspective view of the wiper system depicted in FIG. 1 together with electrodes of the electrochemical cell.

FIG. 3 is a front view of FIG. 2.

FIG. 4 is side view of FIG. 2.

FIG. 5 is a perspective view of the wiper system depicted in FIG. 1 without electrodes of the electrochemical cell.

FIG. 6 is a front view of FIG. 5.

FIG. 7 is side view of FIG. 5.

FIG. 8A depicts a blade support for the wiper system depicted in FIG. 1.

FIG. 8B depicts a wiper blade for the wiper system depicted in FIG. 1.

FIG. 8C depicts an electrode for which the wiper system of FIG. 2 is suited to wipe.

FIG. 9 is a graph of wiper blade deflection (mm) vs. load (N) comparing actual performance of the wiper system of FIG. 2 to finite element analysis (FEA) modeling results for the wiper system of FIG. 2.

FIG. 10 is a perspective view of a second embodiment of a wiper system for wiping an electrode in an electrochemical cell.

FIG. 11 is a perspective view of the wiper system depicted in FIG. 11 together with electrodes of the electrochemical cell.

FIG. 12 is a front view of FIG. 11.

FIG. 13 is side view of FIG. 11.

FIG. 14 is a perspective view of the wiper system depicted in FIG. 10 without electrodes of the electrochemical cell.

FIG. 15 is a front view of FIG. 14.

FIG. 16 is side view of FIG. 14.

FIG. 17A depicts a blade support for the wiper system depicted in FIG. 11.

FIG. 17B depicts a wiper blade for the wiper system depicted in FIG. 11.

FIG. 17C depicts an electrode for which the wiper system of FIG. 11 is suited to wipe.

FIG. 18 is a graph of wiper blade deflection (mm) vs. load (N) comparing actual performance of the wiper system of FIG. 11 to finite element analysis (FEA) modeling results for the wiper system of FIG. 11.

FIG. 19 is a perspective view of a third embodiment of a wiper system for wiping an electrode in an electrochemical cell.

FIG. 20 is an electrode for which the wiper system of FIG. 19 is suited to wipe.

FIG. 21 is a graph of wiper blade deflection (mm) vs. load (N) comparing actual performance of the wiper system of FIG. 19 to finite element analysis (FEA) modeling results for the wiper system of FIG. 19.

### DETAILED DESCRIPTION

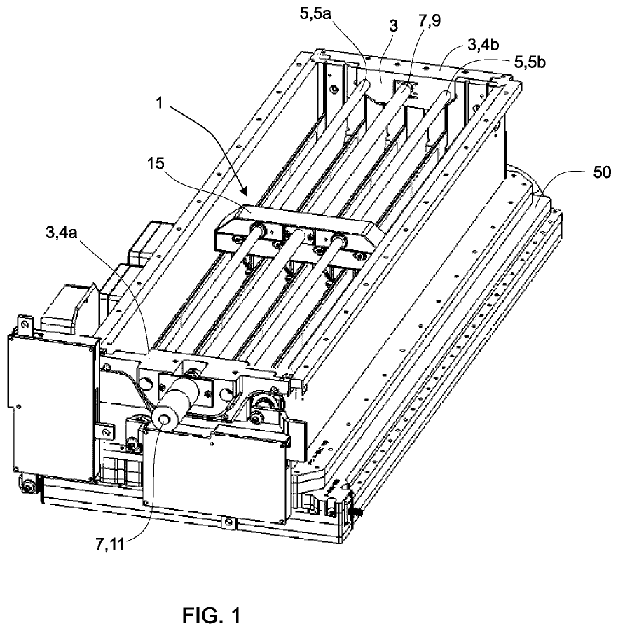

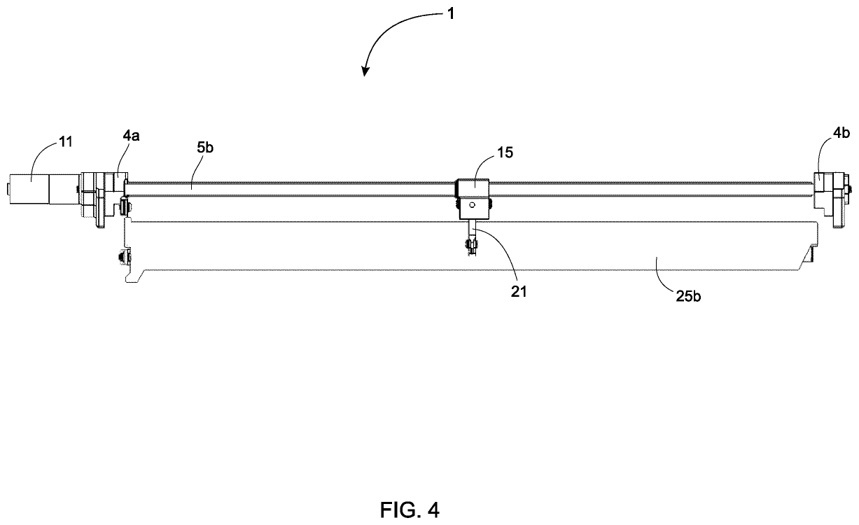

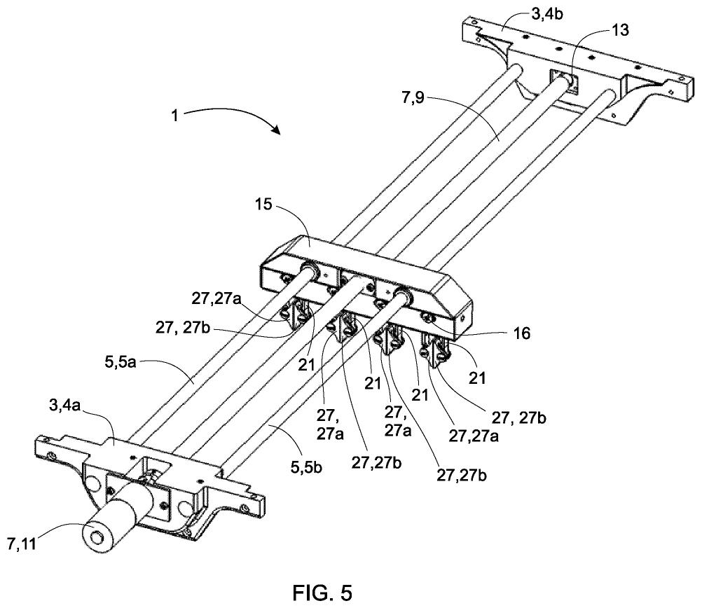

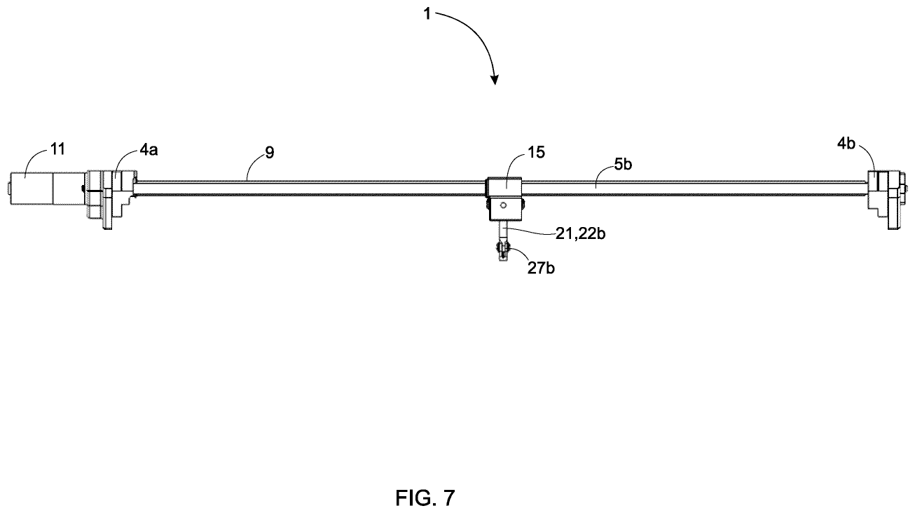

With reference to FIG. 1 to FIG. 9, a first embodiment 1 of a wiper system is shown mounted on a top of an electrochemical cell 50, preferably a charge/discharge storage cell. The cell 50 also comprises a tank for holding an electrolyte along with other usual components found in electrochemical cells. The wiper system 1 comprises a chassis 3 having a front mounting block 4a and a rear mounting block 4b connected together by guide rods 5 extending longitudinally between the mounting blocks 4a, 4b. Two laterally spaced-apart guide rods 5a, 5b are shown, but any convenient number of guide rods may be utilized depending on the size of the chassis 3. The chassis 3 is preferably made of a polymeric material, for example an engineering plastic (e.g., polyoxymethylene (POM)).

The chassis 3 supports a carriage drive 7 comprising a threaded drive rod 9 extending longitudinally between the mounting blocks 4a, 4b and rotatably connected to a motor 11. The threaded drive rod 9 is mounted on a bearing 13 in the rear mounting block 4b and the motor 11 is mounted on the front mounting block 4a so that the carriage drive 7 is mounted on the chassis 3. The motor 11 is preferably electric, but any other motor, for example a gas-powered motor or a hydraulic motor could be used instead.

The carriage drive is shown as a combination of a threaded drive rod (i.e., a lead screw), but any suitable drive mechanism could be employed, as described above.

The carriage drive 7 supports a carriage 15. The carriage 15 has through-apertures therein, each of the guide rods 5 and the threaded drive rod 9 extending though respective through-apertures. The guide rods 5 have smooth surfaces and their respective through-apertures have smooth inner surfaces so that the carriage 15 can translate smoothly while being supported on the guide rods 5. The through-aperture through which the threaded drive rod 9 extends has a threaded inner surface (e.g., the internal threads of a captured nut), the internal threads matingly engaged with the threads of the threaded drive rod 9. Rotation of the threaded drive rod 9 causes the carriage 15 to translate along the drive rod 9 due to the threaded engagement of the drive rod 9 with the threaded inner surface of the through-aperture through which the drive rod 9 extends. The threaded drive rod 9 can rotate in both rotational directions to drive the carriage 15 longitudinally forward and rearward, but the threaded drive rod 9 does not translate with respect to the chassis 3. The carriage 15 is oriented laterally across the chassis 3 with the through-apertures extending between front and rear faces of the carriage 15. In the illustrated configuration, there are two guide rods 5a, 5b situated laterally and symmetrically on either side of the centrally situated drive rod 9, the guide rods 5a, 5b and drive rod 9 extending longitudinally between the mounting blocks 4a, 4b. Centrally situating the drive rod 9 provides for smooth translation of the carriage 15 by reducing twisting forces on the carriage 15 as the threaded drive rod 9 rotates, and the guide rods 5a, 5b further reduce rotational motion (e.g., twisting) of the carriage 15 so that the carriage 15 can move evenly and smoothly back and forth along the drive rod 9. To provide smooth sliding, the through-apertures through which the guide rods 5a, 5b extend have linear bearing quality mechanical fits or bushing inserts.

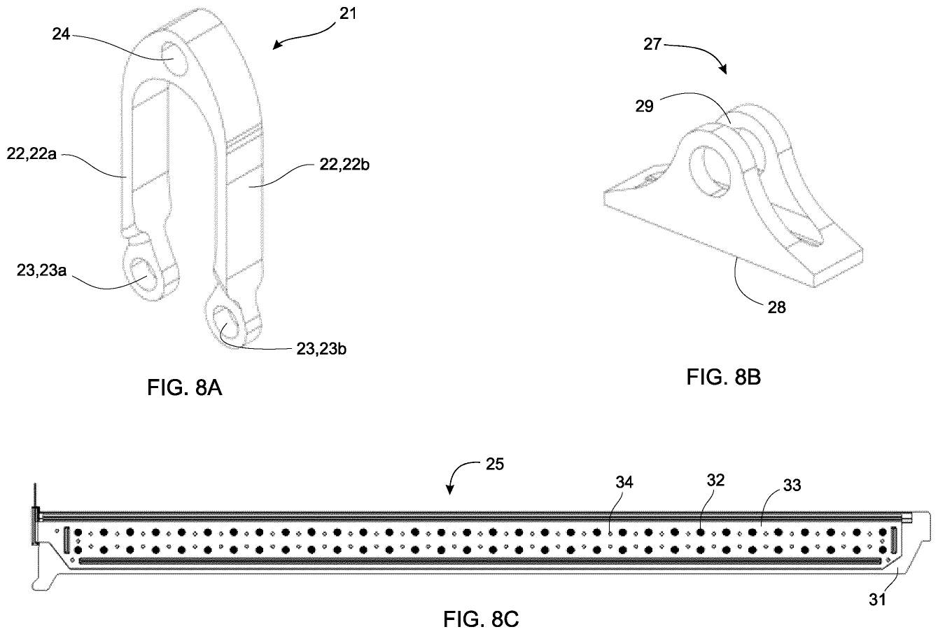

The carriage 15 provides a mount on which one or more blade supports 21 may be mounted. The blade supports 21 are rigidly attached to the carriage 15, for example with pins 16 through slots 17, and extend downwardly from the carriage 15. The slots 17 provide translational and rotational degrees of freedom for positioning the pins 16 to accommodate manufacturing misalignments. Four blade supports 21 are illustrated, but any number of the blade supports may be used depending on the configuration and number of electrodes 25. As seen in FIG. 8A, each blade support 21 comprises a mounting point 24, at least one arm 22 and at least one blade mount 23 proximate an end of the arm 22. In the illustrated embodiment, the blade support 21 is forked, comprising spaced-apart first and second arms 22a, 22b, respectively, having first and second blade mounts 23a, 23b, respectively. The two arms 22a, 22b meet at a mounting point 24, which is shown as an aperture through which the pin 16 (e.g., a bolt, screw, rivet or the like) can be inserted to secure the blade support 21 to the carriage 15. However, any suitable other way of mounting the blade support 21 to the carriage 15 can be used. Further, in some embodiments, each blade support may have only one arm.

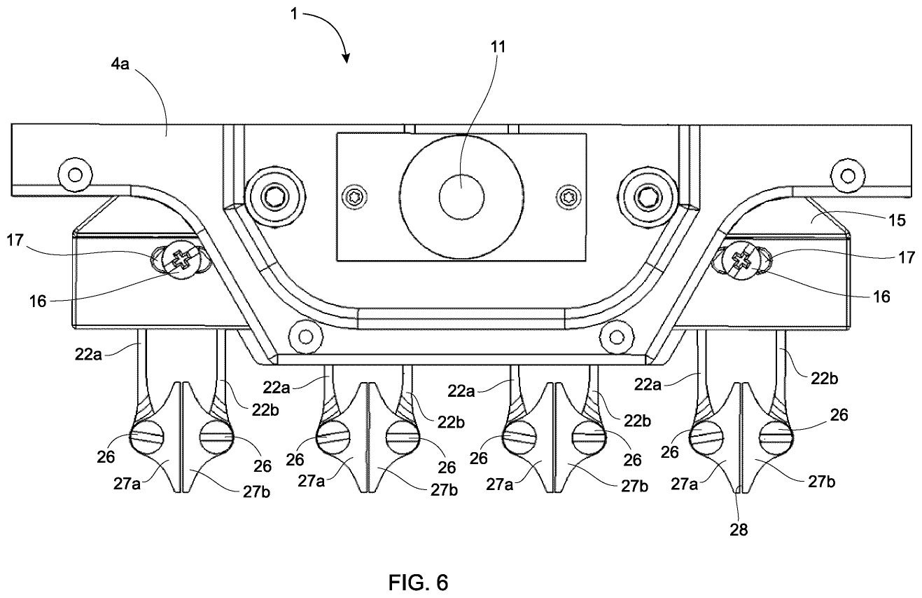

Each blade support 21 supports at least one wiper blade 27 mounted thereon. In this embodiment, first and second wiper blades 27a, 27b, respectively, are mounted on one blade support 21 at the first and second blade mounts 23a, 23b, respectively. As seen in FIG. 8B, each wiper blade 27 comprises a wiping surface 28 that contacts a surface of an electrode during operation of the wiper system 1 and a mounting clevis 29 that brackets one of the blade mounts 23 so that another pin 26 (see FIG. 6) can be inserted through aligned apertures of the clevis 29 and an aperture in the blade mount 23 to secure the wiper blade 27 to the blade mount 23. However, any suitable other way of mounting the wiper blade 27 on the blade mount 23 can be used. In the illustrated embodiment, the wiping surfaces 28 of the first and second wiper blades 27a, 27b face each other so that opposed faces of one electrode 25 can be wiped by the wiper blades 27 mounted on a single blade support 21.

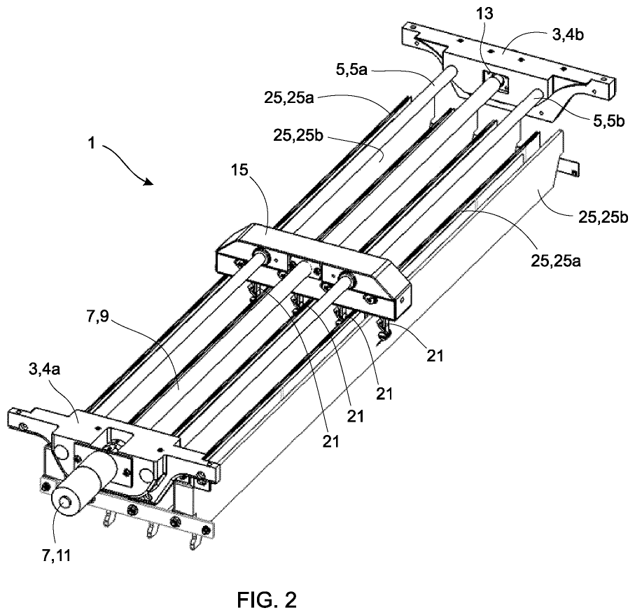

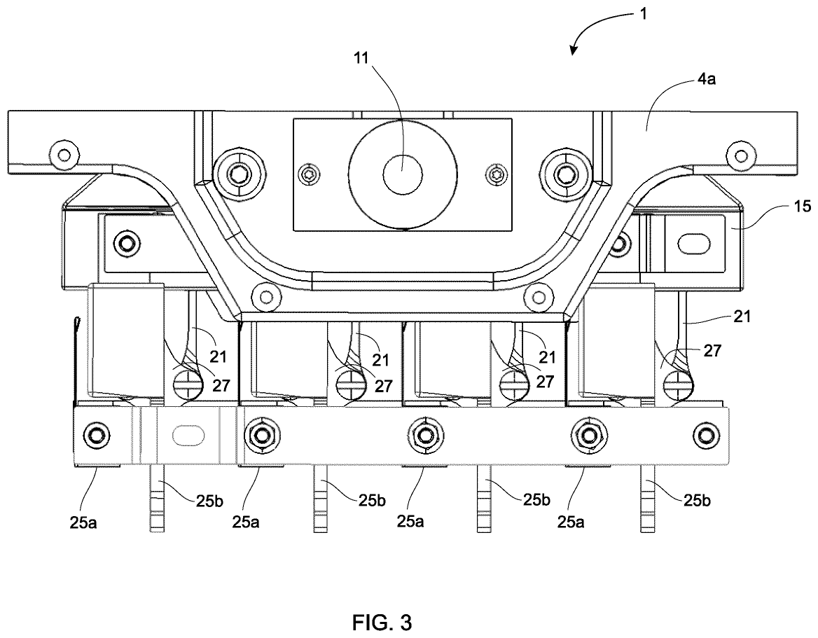

As seen best in FIG. 2 and FIG. 3, the electrodes 25 are formed of or in strips of material arranged parallel to each other extending longitudinally between the mounting blocks 4a, 4b. The electrodes 25 comprise anodes 25a (e.g., charging anodes) and cathodes 25b (e.g., charging cathodes). The anodes 25a and cathodes 25b alternate laterally. The blade supports 21 are in a row spaced apart laterally from each other with respect to a direction of translation of the carriage 15 so that each blade support 21 is sufficiently close to one of the electrodes 25, especially one of the cathodes 25b, for the first and second wiper blades 27a, 27b, respectively, to wipe both faces of the electrode 25.

The first and second wiper blades 27a, 27b, respectively, are opposed to each other and are biased toward each other by the first and second arms 22a, 22b, respectively. The blade support 21, including the first and second arms 22a, 22b, comprises a resilient polymer material, for example an engineering plastic (e.g., an acrylic polymer), whereby the resiliency of the polymer material biases the wiping surfaces 28 of the wiper blades 27a, 27b toward the surfaces of the electrode 25. Other ways of biasing the wiper blades 27a, 27b can be used, for example actuators, springs and the like, but the use of a resilient polymer material is simpler and more robust. Further, the mounting clevis 29 of each wiper blade 27 is located in a middle portion of the wiper blade 27 so that the arm 22 of the blade support 21 applies a biasing force to the middle portion of the wiper blade 27 to balance load along the wiper blade 27 when the wiping surface 28 of the wiper blade 27 is in contact with the surface of the electrode 25. Furthermore, the wiper blade 27 is cambered to generate a uniformly distributed normal force profile to the electrode 25 over the length of the wiper blade 27. The wiper blade 27 is preferably also made of a polymer material, for example an engineering plastic (e.g., an acrylic polymer).

The wiper system 1 is most suitable for wiping an electrode 25 of the dimensions and configuration shown in FIG. 8C. The electrode 25, particularly a charging cathode, suitably comprises a conductive metal (e.g., steel) plate 33 (current collector) having graphite pellets 32 (only one labeled) inserted through through-apertures in the metal plate 33 so that the pellets 32 protrude from both of the opposed surfaces of the metal plate 33. The metal plate 33 is insulated on both faces with a layer of cured epoxy resin 31 leaving end surfaces of the pellets 32 exposed but flush with the surface of the layer of cured epoxy resin 31. Smaller holes 34 in the metal plate 33 improve adhesion between the layer of cured epoxy resin 31 and the metal plate 33. The electrode 25 has high electrical conductivity, low adhesion for easy Zn removal when the electrode 25 is a charging cathode, and simplicity to adjust arrays of the electrochemical cell according to electrode design requirements for different applications. Surface area, active site distribution, size and shape of the electrode 25 can be easily adjusted to change the operating conditions for different applications. Bench-scale tests were performed using charging cathodes of two graphite diameters, 1 mm and 6.35 mm, under variable current densities, zincate concentration, and wiping intervals. The results showed low adhesion of Zn even at low currents and high charge efficiency at high currents.

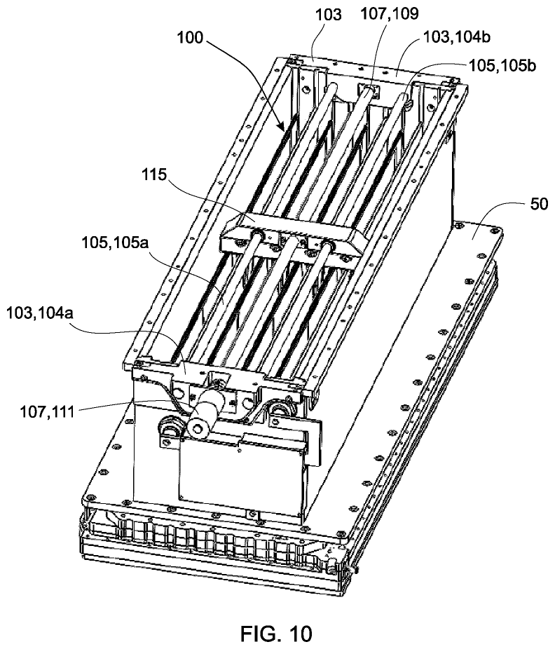

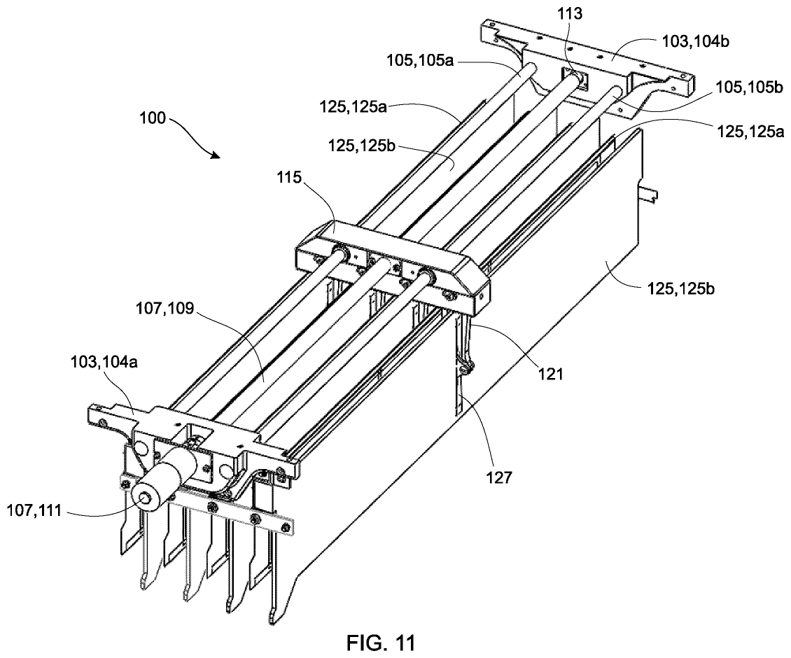

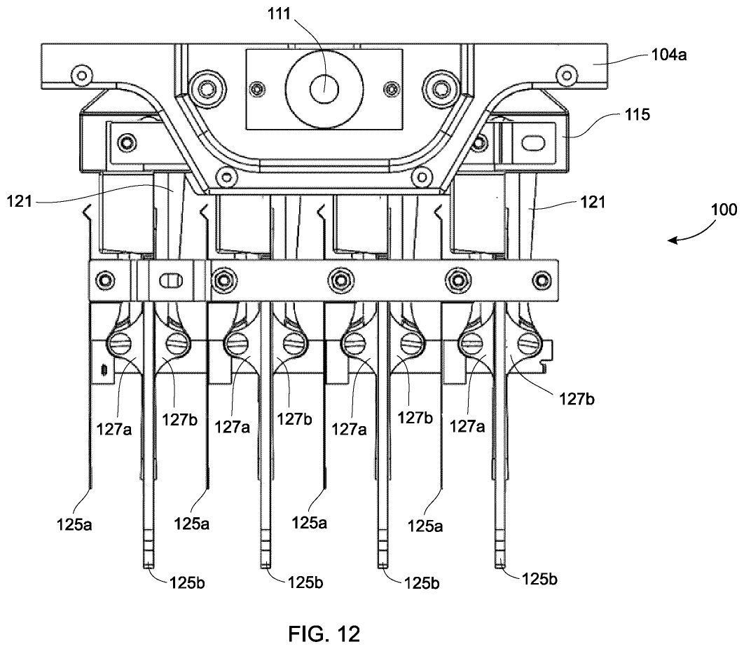

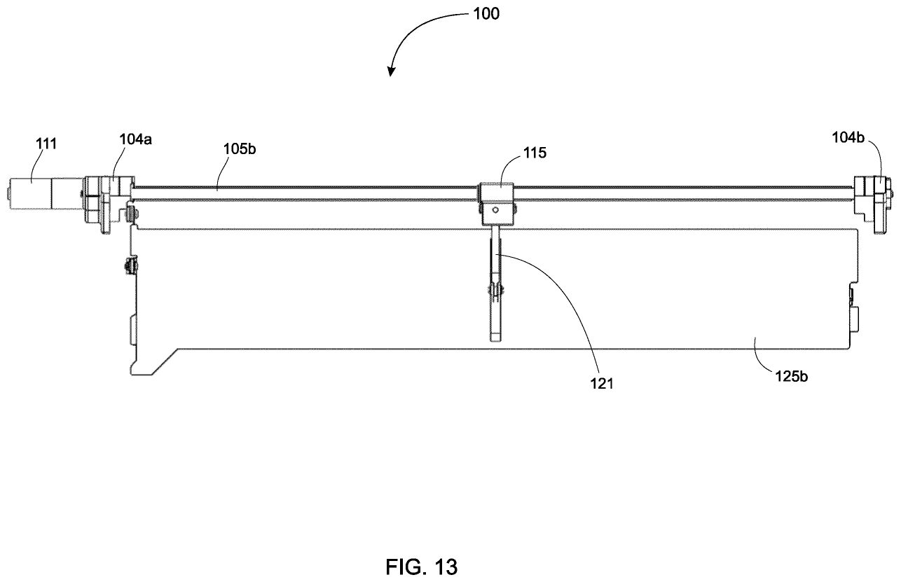

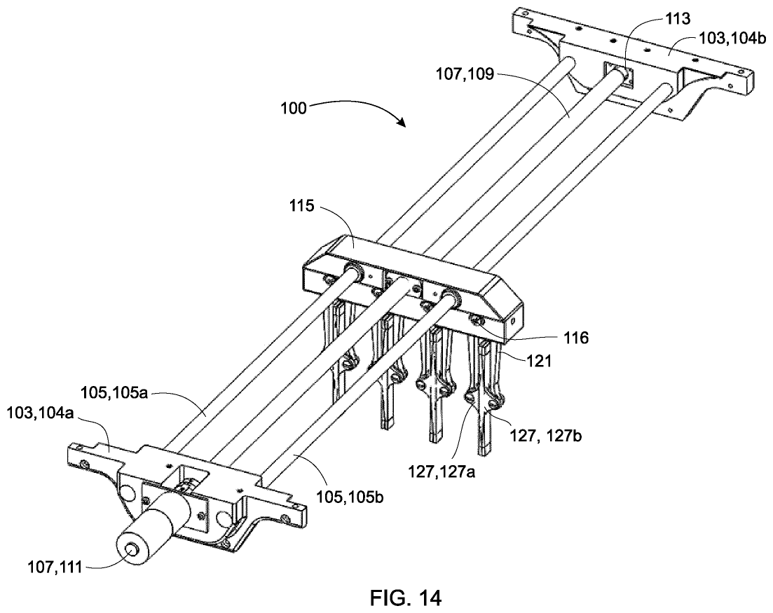

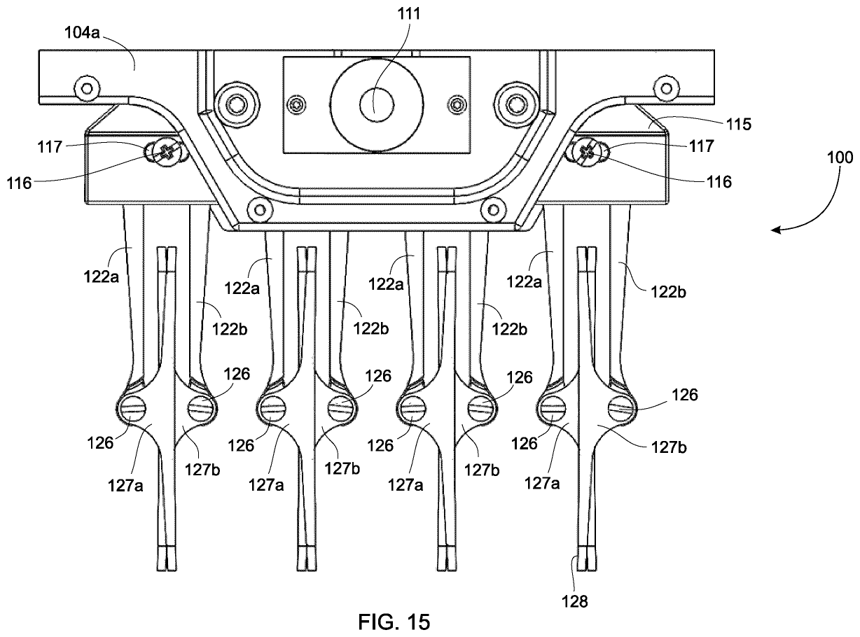

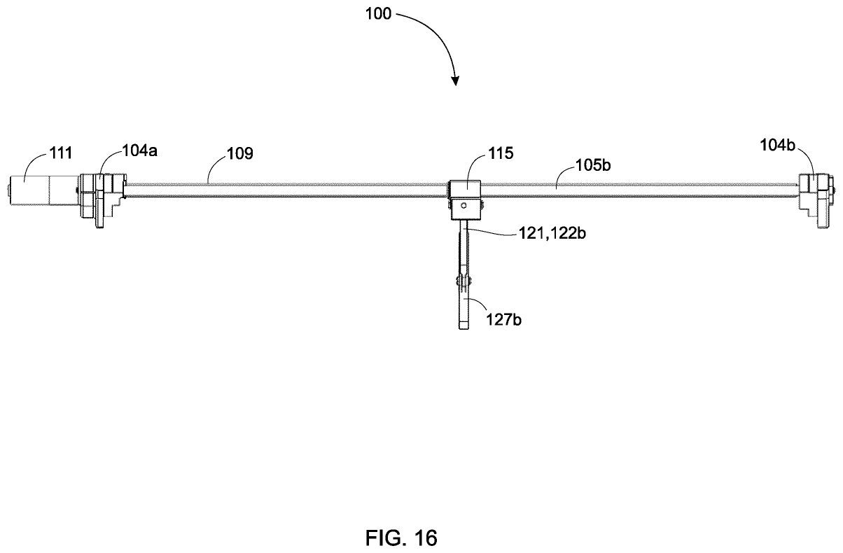

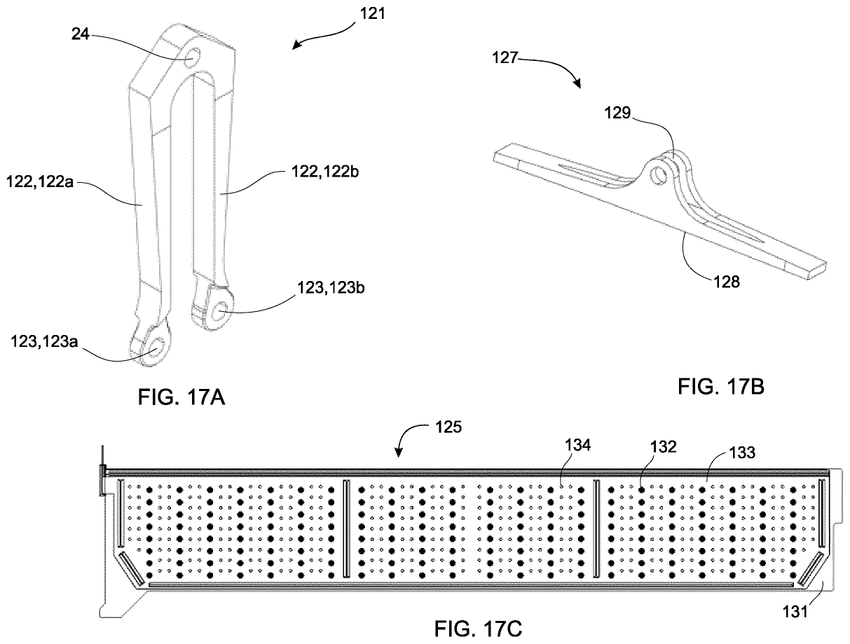

With reference to FIG. 10 to FIG. 18, a second embodiment 100 of a wiper system is shown mounted on a top of an electrochemical cell 50. The wiper system 100 comprises a chassis 103 having a front mounting block 104a and a rear mounting block 104b and guide rods 105, a carriage drive 107 comprising a threaded drive rod 109 and a motor 111, a carriage 115, blade supports 121 comprising arms 122 (spaced-apart first and second arms 122a, 122b, respectively), having blade mounts 123 (first and second blade mounts 123a, 123b, respectively), and wiper blades 127 (first and second wiper blades 127a, 127b, respectively), the wiper blades 127 having wiping surfaces 128 and mounting clevises 129. The blade supports 121 are rigidly attached to the carriage 115, for example with pins 116 through slots 117, and extend downwardly from the carriage 115. The slots 117 provide translational and rotational degrees of freedom for positioning the pins 116 to accommodate manufacturing misalignments. The wiper system 100 is the same as the wiper system 1 except that the blade supports 121, while still being forked, are of a somewhat different shape than the blade supports 21, the arms 122 of the blade supports 121 are longer than the arms 22 of the blade supports 21, and the wiper blades 127 are longer than the wiper blades 27, as seen when comparing FIG. 17A and FIG. 17B to FIG. 8A and FIG. 8B. Given the difference in length of the wiper blades 127, the dimensions of an electrode 125 for which the wiper system 100 is suitable to wipe are also different (compare FIG. 17C to FIG. 8C). The electrode 125 also comprises a conductive metal (e.g., steel) plate 133 (current collector) having graphite (cathode) pellets 132 (only one labeled) inserted through through-apertures in the metal plate 133 so that the pellets 132 protrude from both of the opposed surfaces of the metal plate 133. The metal plate 133 is insulated on both faces with a layer of cured epoxy resin 131 leaving end surfaces of the pellets 132 exposed but flush with the surface of the layer of cured epoxy resin 131. Smaller holes 134 in the metal plate 133 improve adhesion between the layer of cured epoxy resin 131 and the metal plate 133.

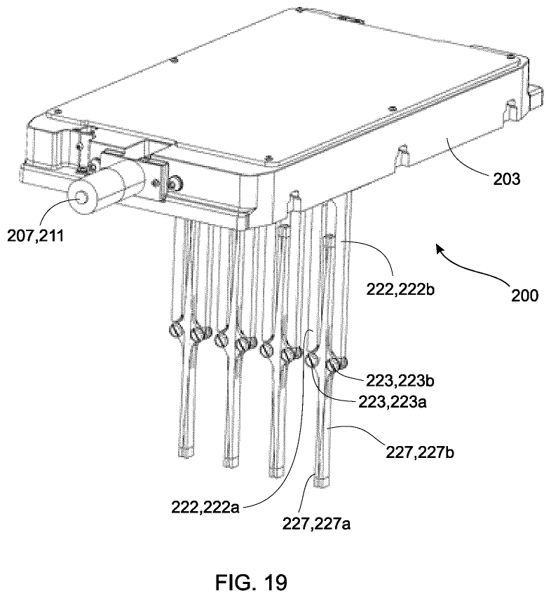

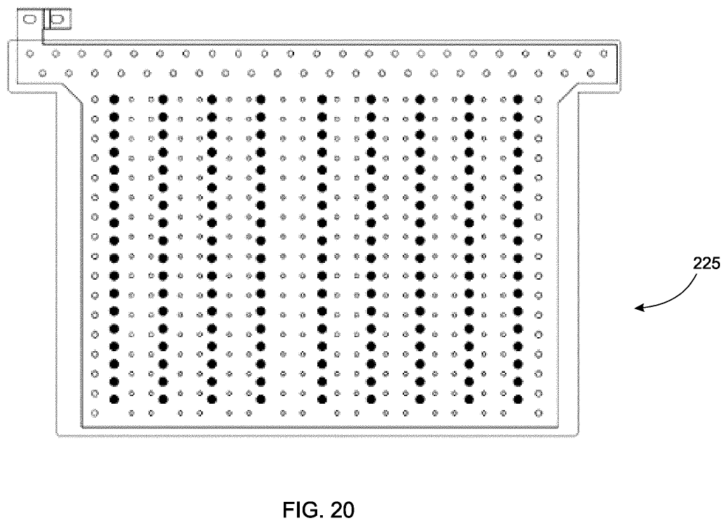

With reference to FIG. 19 to FIG. 21, a third embodiment 200 of a wiper system comprises a monolithic chassis 203 with guide rods extending inside the chassis 203 between a front and rear of the chassis 203. A carriage drive 207 comprising a threaded drive rod and a motor 211 are mounted in the chassis 203. A carriage is mounted on the threaded drive rod, the carriage having blade supports mounted thereon. The blade supports comprise arms 222 (spaced-apart first and second arms 222a, 222b, respectively), having blade mounts 223 (first and second blade mounts 223a, 223b, respectively), and wiper blades 227 (first and second wiper blades 227a, 227b, respectively). Given the difference in length of the wiper blades 227, the dimensions of an electrode 225 for which the wiper system 200 is suitable to wipe are also different (compare FIG. 8C and FIG. 17C to FIG. 20).

Operation of the wiper system 200 is the same as operation of the wiper systems 1 and 100, but there are several design features of the wiper system 200 that are different. The wiper system 200 has higher pre-load in the wiper blades 227, largely due to the shape of the blade supports and longer length of the wiper blades 227, but also has the largest wiping area. Insufficient pre-load for the wiping area could result in smearing of deposits (e.g., zinc) across the electrode that could grow into large contiguous masses that later could cause broken blades. Further, the chassis 203 of the wiper system 200 is one large monolith machined out of a single block of material and resting on the top of the cell tank, which is costly. The guide rods are farther to the extreme lateral edges of the chassis 203. In contrast, the wiper systems 1 and 100 utilize a 3-piece design, with the wiper blades 27, 127. The wiper systems 1, 100 provide less localized stress on the arms 22, 122 and the wiper blades 27, 127. Further, the chassis 3, 103 the wiper systems 1, 100 are split into front and rear components. The wiper systems 1, 100 reduce or eliminate binding of the carriage 15, 115 under all loading conditions because the guide rods 5, 105 are closer to the drive rod 9, 109 for ideal guide bushing design (the ratio of the guide rod to lead screw distance relative to the distance between the bushing surface extremes in the fore/aft direction of the carriage). This reduced the racking moment (Mx) applied to the carriage 15, 115 so that the carriage 15, 115 would no longer bind under high and/or offset load conditions.

The wiper blades 227 are 26.5 cm long, while the wiper blades 127 are 12.5 cm long and the wiper blades 27 are 3.2 cm long. Shorter wiper blades and arms reduce the ‘cantilever effect’ (My) that introduces a large amount of deflection at the distal ends of the wiper blade for a given zinc removal force, and decrease the number of zinc sites that the wipers see thereby decreasing the force that the wipers experience. Both of these effects reduce wiper breakage and increase the wipe quality. Therefore, the wiper blades preferably have a length in a range of 1.0-15 cm, more preferably 1.5-12.5 cm.

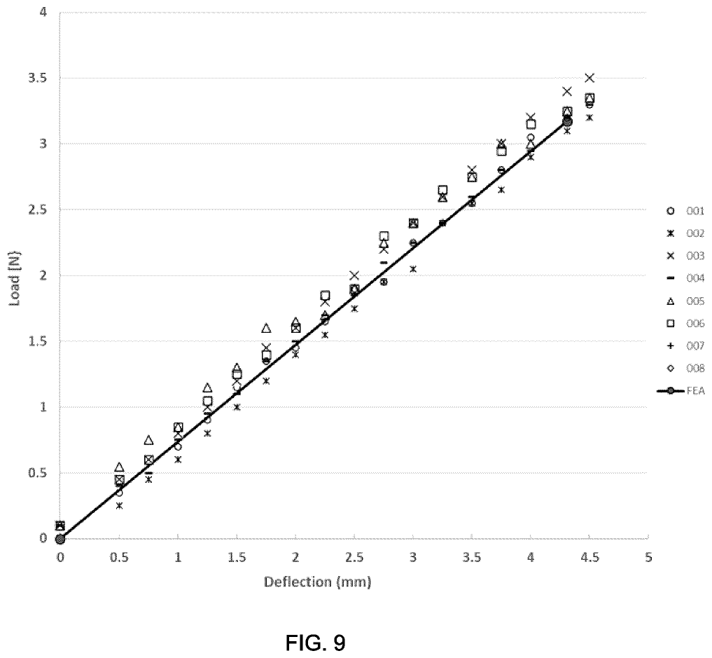

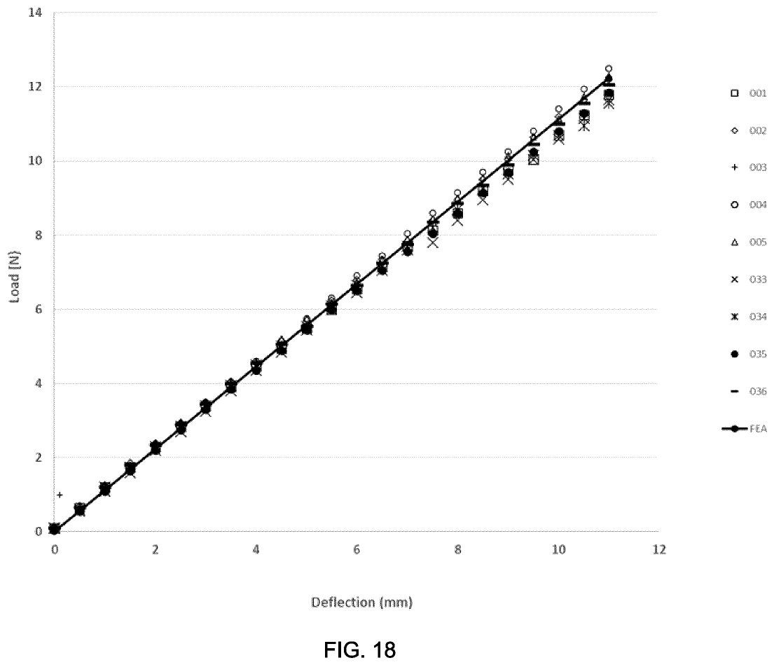

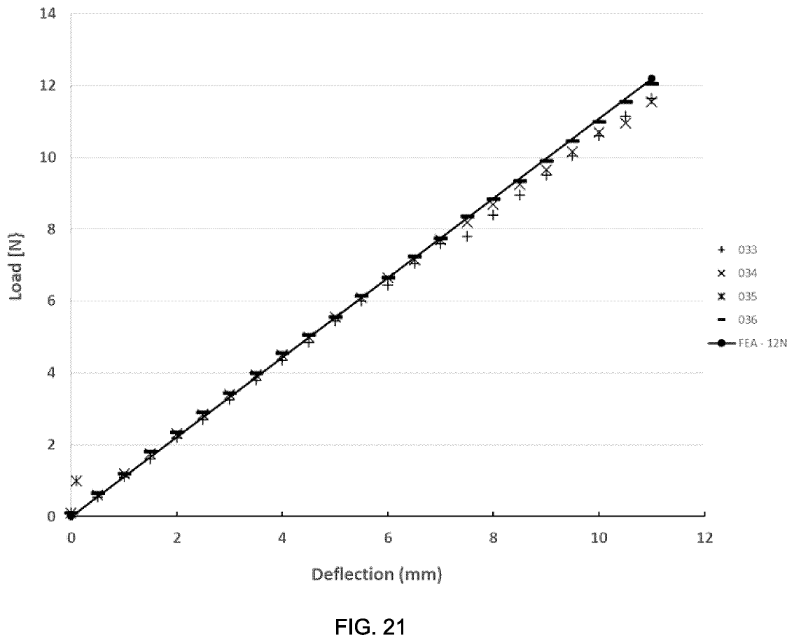

The blade mounts and wiper blades must be able to handle the desired zinc load scenarios (fore/aft loading) and the as-loaded installed condition (arm extension and wiper blade deflection) without yielding under the highest load conditions or under fatigue through prolonged use. FEA analysis of the wiper blades and the arms of the blade mounts was used to design the arms and wiper blades to meet such criteria. Empirical testing was performed to arrive at optimal normal force on the wiper blades in the wiper systems 1, 100 and 200 to ensure that the wiping process was as efficient as possible within the desired current density and molarity ranges. As seen from FIG. 9, FIG. 18 and FIG. 21, for each of the wiping systems, the nominal normal force applied to the electrode was maintained or increased while maintaining or reducing the stress on the arms and wiper blades, thus reducing the high loads and fatigue and eliminating occurrences of mechanical failures. Further, for each of the wiping systems, the force deflection of the arm increases linearly, in agreement with the FEA model, thereby showing that the wiping systems are able to withstand forces that are required to wipe zinc off the electrode surface without breaking.

In comparison to the wiper system 100, the wiper system 1 has lower cantilever loads from the carriage to the center of action of the wiper blades which deliver the uniformly distributed normal force, and thus wiper system 1 less prone to deflection/breakage from the fore/aft drive action of wiping. The wiper system 1 also allows for less cost from the electrode and reduced cell cube size. However, in some use cases such as renewable integration, the wiper system 100 is preferred over the wiper system 1 because the wiper system 100 enables a fast-charge capability. Thus, the wiper system 1 has lower cost and better reliability due to less cantilever load, but is more suited to trickle charging for shallow cycling and back-up power use cases. The wiper system 200 has a taller and shallower wiper stroke than the wiper systems 1 and 100. Because electrode size follows cell cube size, and the wiper stroke follows the electrode size, the use of any given embodiment of the wiper system stems from a higher-level strategic decision on final system packaging and market use case. The various embodiments described herein enable tuning of the charging current ranges for different applications.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A wiper system for an electrode in an electrochemical cell, the wiper system comprising:
a wiper blade configured to contact a surface of the electrode;
a blade support having a blade mount on which the wiper blade is mounted, the blade support configured to bias the wiper blade toward the surface of the electrode to provide a contact force between a surface of the wiper blade and the surface of the electrode;
a translatable carriage on which the blade support is mounted;
a carriage drive on which the carriage is mounted, the carriage drive configured to translate the carriage through space; and,
a chassis on which the carriage drive is mounted, the chassis permitting the wiper blade to contact the electrode during operation of the wiper system.

2. The system of claim 1, wherein the blade support comprises a resilient polymer material, whereby the resiliency of the polymer material biases the wiper blade toward the surface of the electrode.

3. The system of claim 1, wherein the blade support applies a biasing force to a middle portion of the wiper blade to balance load along the wiper blade when the wiper blade is in contact with the surface of the electrode.

4. The system of claim 1, wherein the wiper blade is cambered to generate a uniformly distributed normal force profile to the electrode.

5. The system of claim 1, wherein the carriage drive comprises a threaded drive rod and the carriage comprises an internally threaded aperture, the drive rod threaded into the threaded aperture so that rotation of the drive rod causes the carriage to translate through space along the threaded drive rod.

6. The system of claim 5, wherein the threaded drive rod rotates in both rotational directions but does not translate with respect to the chassis.

7. The system of claim 5, wherein the carriage drive comprises a motor rotationally coupled to the drive rod for rotating the drive rod.

8. The system of claim 5, wherein the internally threaded aperture is provided by a captured nut.

9. The system of claim 5, further comprising at least two guide rods mounted on the chassis parallel to the drive rod, the moveable carriage mounted on the at least one guide rod to reduce rotational motion of the carriage as the carriage translates on the drive rod.

10. The system of claim 1, wherein the blade support is a first blade support and the wiper system comprises at least one other blade support mounted on the moveable carriage, the blade supports spaced apart laterally from each other with respect to a direction of translation of the moveable carriage.

11. The system of claim 1, wherein:
the blade support is forked, comprising spaced-apart first and second arms having first and second blade mounts, respectively;
the wiper blade is a first wiper blade mounted on the first blade mount; and,
the wiper system further comprises a second wiper blade mounted on the second blade mount,
wherein the first and second wiper blades are opposed to each other and are biased toward each other by the first and second arms.

12. An electrochemical cell comprising:
a tank for holding an electrolyte;
at least one electrode disposed in the electrolyte, the at least one electrode having a surface on which metal deposits during operation of the cell; and,
a wiper system of claim 1 mounted to the tank so that the wiper blade is in contact with the surface on which metal deposits and the carriage translates along the electrode.

13. The electrochemical cell of claim 12, wherein:
the blade support is forked, comprising spaced-apart first and second arms having first and second blade mounts, respectively;
the wiper blade is a first wiper blade mounted on the first blade mount; and,
the wiper system further comprises a second wiper blade mounted on the second blade mount,
wherein the first and second wiper blades are opposed to each other and are biased toward each other by the first and second arms.

14. The electrochemical cell of claim 13, wherein the first and second wiper blades scrape opposed surfaces of the same electrode.

15. The electrochemical cell of claim 12, wherein the electrode comprises a charging cathode.

16. The electrochemical cell of claim 12, wherein the at least one electrode is a plurality of the electrodes and the wiper system comprises a plurality of the blade supports mounted on the carriage, each blade support having two wiper blades mounted thereon.
